(19) United States
(12) Patent Application Publication
(10) Pub. No.: US 2022/0193578 A1
(43) Pub. Date: Jun. 23, 2022

(54) WATER FILTER AND WATER FILTRATION APPARATUS

(71) Applicants: Shimon Ben Dor, Kfar Adumin (IL); Ronald SILVER, Bluffton, SC (US)

(72) Inventors: Shimon Ben Dor, Kfar Adumin (IL); Ronald SILVER, Bluffton, SC (US)

(21) Appl. No.: 17/131,828

(22) Filed: Dec. 23, 2020

(51) Int. Cl. B01D 24/00; C02F 1/00; B01D 35/30; B01D 24/12

(52) U.S. Cl. CPC B01D 24/007; C02F 1/001; B01D 2201/307; B01D 24/12; B01D 35/303

(57) ABSTRACT

The disclosure relates to devices and systems for configurable, contaminat-specific water filtration and treatment. In particular, the disclosure relates to a contaminant-specific configurable and modular horizontal water filter and a water filtration system, comprising modular housings, each housing defining a plurality of reconfigurable compartments operable to accommodate contaminant-specific filtering units.

### BACKGROUND

The disclosure is directed to the devices and systems for configurable, contaminat-specific water filtration and treatment. In particular, the disclosure is directed to a contaminant-specific configurable and modular horizontal water filter and a water filtration system, comprising modular housing, each housing defining a plurality of compartment operable to accommodate contaminant-specific filtering units.

With the increasing world population and a limited amount of drinkable water available in the world, the water demand is also increasing and is going to further increase in the future. In some parts of the world where the local population is growing at a much higher rate than average, the availability of safe drinking water is lower than average. Geography along with inefficient management of available water plays a major contribution to this situation, whether from an arid climate or simply the lack of fresh surface water suitable for drinking, along with uncontrolled increasing water pollution. Examples of such settings may include rural villages in under-developed countries, an area nearby industrial sites in almost every country, emergency relief sites following natural disasters, or camp settings, to name a few.

Water filtration and treatment systems are being used by people around the world for many decades to convert water into a drinkable or consumable form. Governments around the world have set up various municipal water treatment plants to filter and treat the water and provide the same to their population, However, in many locales where water is very scarce, the population is unable to purchase water for consumption due to their low-income levels and the fact that municipally treated water is unavailable.

Various water filtration devices are available in the market, which is being used in households, schools, hospitals, and other individual locales, to reduce the dependency of the population on municipally treated water. These water filtration devices are mainly equipped with a gravity-based sediment filter and/or Reverse Osmosis (RO) technology that majorly filters out pollutants or solutes from the water while flowing through them. Some filtration devices are equipped with UV lamps to kill microorganisms present in the water. However, these filtration devices fail to efficiently neutralize and filter contaminants including harmful metals, non-metals, and other chemical compounds present in the water.

Few filtration devices available in industries use a filter having a specific material for neutralizing a specific contaminant or chemical compound. However, water generally comprises many harmful compounds or contaminants along with solutes and other harmful microorganisms depending on the locality. For instance, Arsenic is dominantly present in the water of Asian countries. Further, mercury, fluoride, lead, and other chemicals are also present in many localities around the world. The use of multiple filtration devices for neutralizing different chemicals in multiple steps is possible, however, it becomes inefficient and costly for a normal individual (users). Thus, there is a need in the art to provide a simple and easy to use water filter and a water filtration device that allow users to efficiently configure different filtration media specific to different contaminants or chemicals in a single water filter depending on the contaminants present in the water.

In addition, the existing filtration devices employing specific filtration media allows water to flow from top to bottom through the filtration media so that the specific contaminant can be filtered or neutralized. However, these filtration devices fail to efficiently filter and neutralize the chemicals or contaminants as the water may either directly flow only through a smaller portion (generally central portion) of the filter media or the water may quickly flow through the filter media. As a result, the water does not get ample time to efficiently interact with the constituents of the filter media. Further, as the water flows only through a smaller or central portion of the filter media, that portion of the filter media may quickly degrade or become ineffective, while the other portions of the filter which least interacted with water may remain unutilized.

There is, therefore, a need to overcome the above shortcomings and provide a water filter and a water filtration apparatus that allow easier configuration of multiple contaminant specific filtration media in a single filter and enable efficient flow of the water through each of the filtration media for efficient and enhanced filtration and neutralization of different contaminants present in the water.

### BRIEF DESCRIPTION OF THE DRAWINGS

For a better understanding of contaminant-specific configurable and modular water filter and a water filtration systems disclosed, and the exemplary implementations thereof, reference is made to the accompanying examples and figures, in which similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates a top right isometric view of an exemplary implementation of the proposed filter having an inlet in form of slots on top surface of a housing of the filter, with FIG. 1B illustrating a bottom right isometric view of the exemplary implementation of FIG. 1A, having an outlet in form of slots on a bottom surface of the housing;

FIG. 2 illustrates an exemplary top left cutaway isometric view of the exemplary implementation of the proposed filter;

FIG. 3A illustrates an exemplary view of a partition of the proposed filter , with FIG. 3B illustrating the partition of FIG. 3A when rotated by an angle of 180 degrees;

FIG. 4 illustrates an exploded view of the exemplary implementation of the proposed filter;

FIG. 5 is a schematic illustrating the flow of water in the proposed filter as enabled by the alternating opening in the partitions.

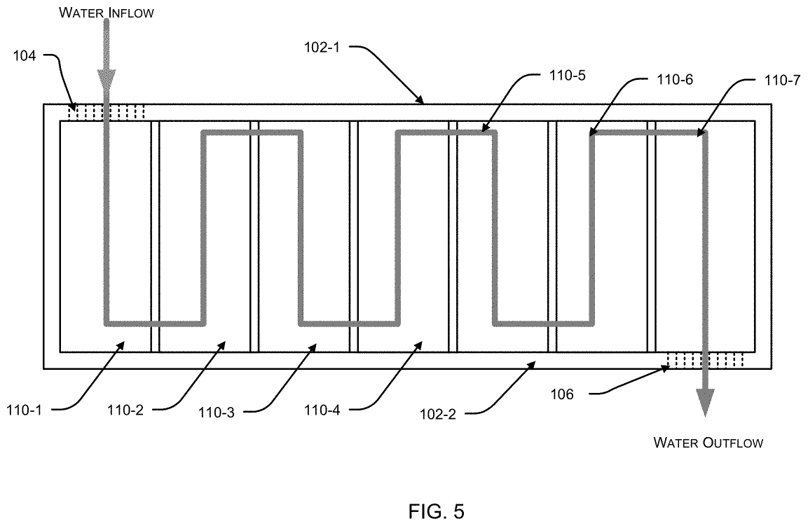

FIG. 6 illustrates the flow of water in another exemplary implementation of the proposed filter in left and right direction.

FIG. 7 illustrates an exemplary view of the proposed water filtration apparatus .

### DETAILED DESCRIPTION

Provided herein are exemplary implementations of a modular, contaiminat configurable water filter, configurable for multiple contaminant-specific filtration media in a single filter, and enable efficient flow of the water through each of the filtration media for efficient and enhanced filtration and neutralization of different contaminants present in the water. The proposed filter comprises a housing having an inlet to receive water from a water reservoir, and an outlet opening to discharge water out of the housing. The filter comprises a plurality of partitions being placed within the housing to form multiple compartments each in fluid communication with an adjacent compartment inside the housing. Each of these compartments is operable accommodate a filtration media corresponding to the contaminants sought to be filtered or neutralized in the water. The partitions define a plurality of opening at their first end, and a second end of the partitions opposite to the first end having a solid surface.

The partitions are configured in the housing such that two adjacent partitions are oriented in opposite direction (rotated by 180 degrees) from each other so that the apertures of one of the two adjacent partitions faces the solid surface of the second end of the other adjacent partition. The inlet is configured on a surface of the housing in a compartment at the first end of the housing. The outlet is configured on a surface of the housing in a compartment at a second end (opposite to the first end) of the housing. This configuration of alternate 180 degrees rotated partitions allows water to flow from the inlet to the outlet through a length of each of the compartments so that the contaminants present in water gets ample time to efficiently interact with the whole area of the filtration media, thereby providing efficient and enhanced filtration of water.

As indicated, the modular, contaminant-specific filtering system disclosed herein is configured to be positioned horizontally, such that flow of liquid is directed from the inlet, through the housing to theoutlet, in an undulating pattern through all the filtering modules placed within the housing. To ensure as complete a flow as possible, the first partition is configured such that the opening(s) defined toward the basal end of the partition, with the partition defining the downstream wall of the compartment, defined toward the apical end of the partition, and from there in an alternating configuration to the outlet opening(s).

The disclosed technology provides a water filtration apparatus that allow easier configuration of a plurality of contaminant-specific filtration media, enclosed in certain exemplary implementations, in water permeable bags, enabling the efficient flow of the water through each of the filtration media for efficient and enhanced filtration and neutralization of different contaminants present in the water. The proposed water filtration apparatus and system comprises a first reservoir operable to store water to be filtered. The apparatus comprises at least one filter positioned below the first reservoir. The filter comprises a housing defining an inlet opening(s) to receive water from the first reservoir, and an outlet opening(s) defined dewonstream toward the housing's distal end to discharge filtered water out of the housing after filtration. The filter comprises a plurality of partitions being placed in parallel within the housing to form compartments inside the housing. In an exemplary implementation, the partitions are disposed perpendicular to the top surface of the housing and transverse to the longitudinal axis XL defined by the housing. Each of these compartments is shaped and sized to accommodate a filtration media container corresponding to a specific contaminant sought to be filtered, removed or neutralized in the water. The partitions are operable to maintain liquid communication between adjacent compartments, for example, in certain configurations, the partitions define an opening (or plurality of openings) at their apical end, with the basal end having a solid surface. The partitions are modular, and symmetric such that two adjacent partitions are oriented in opposite direction (rotated by 180 degrees) from each other so that the opening(s) of one of the two adjacent partitions faces the solid surface of the second end of the other adjacent partition. The inlet opening(s) defined in the lid posrtion of the housing, corresponding to the first (upstream) compartment at the upstream end of the housing. The outlet opening(s) defined at the downstream end's bottom surface of the housing. This configuration of alternate 180 degrees rotated modular partitions within the housing forces water to flow from the inlet to the outlet through each of the compartments under the effect of gravity so that the contaminants present in water gets ample time to efficiently interact with the whole area of the contaminant-specific filtration media container, thereby providing efficient and enhanced filtration of water.

The filtration media container used in the configurable, modular filtering systems disclosed herein, comprise one or more materials of predefined composition being configured in different bags, based on the contaminants to be filtered, removed, or neutralized. Depending on the number of different contaminants present in the water or contaminants to be treated, removed, filtered, or neutralized by the system, a desired number of partitions can be placed within the housing to form a predetermined number of compartments equivalent to the number of bags or filtration media container(s) required. The bags are made of a material that is capable of allowing the water to pass through them but restrict the filtration media present in the unit from leaching out of the bags. The bags are made in certain exemplary implementations, from biodegradable cloth. In the context of the disclosure, the term “bags” is interchangeable with “container” and/or “boxes” and intends to encpompass other materials, such as plastic, metal, wood and other reusable materials that will enable the removal of spent filtering medium. The use of recyclable and resusavble material is beneficial for lowering the carbon footprint of the system when in use. Furthermore, using plastic container in certain implementations, assist in the efficient filling of the filtering material into the containers, and their placement within the compartments formed by the even number of partitions.

In certain exemplary implementations, the housing accommodating the filtration media container(s), is operable to couple to other housing, such that an outlet opening defined toward the downstream end of a housing, is adapted sized and configured to couple to the inlet opening defined on an upstream end of another housing, thus forming a column of filters. Accordingly and in yet another exemplary implementation, provided herein is a filtration system comprised of a plurality of vertically stacked filtration housings, each filtration housing operable to accommodate a plurality of filtration media containers, separated by a plurality of I-shaped cross-section partitions having reflectional symmetry, whereby each partition defines on opening toward an apical or basal end thereof, the partitions releasably slidably coupled to the housing via a plurality of railings' pairs configured to accommodate the flanged portion of the I-shaped partition.

Additionally, or alternatively, the housing accommodating the filtration media container(s), is operable to laterally couple to other housings, such that an outlet opening defined toward the downstream end of a housing, is adapted sized and configured to be adjacent to the outlet opening defined a downstream end of another housing, thus forming an array of filters (or an array of filtering columns). Accordingly and in an exemplary implementation, provided herein is a filtration system comprised of a plurality of laterally coupled filtration housings, each filtration housing operable to accommodate a plurality of filtration media containers, separated by a plurality of I-shaped cross-section partitions having reflectional symmetry, whereby each partition defines on opening toward an apical or basal end thereof, the partitions releasably slidably coupled to the housing via a plurality of railings' pairs configured to accommodate a the flanged portion of the I-shaped partition.

The contaminants present in the water can be, for example, at least one of: dissolved solutes, microorganisms, Arsenic, Fluoride, Mercury, lead, and the likes. The materials in the filtration media container(s) can be selected based on the type of contaminant to be filtered or neutralized. Accordingly, the number of filtration media and the partition and compartment can be provided in the proposed filter. Likewise, in another example, the filtration media can be at least one of: activated carbon, quartz, iron (sulfate, chloride etc.), chitosan, neodymium particulates, samarium cobalt particulates, AlNiCo particulates, Alumina powder and its salts (e.g., sodium, chlorohydrate, sulfate and the like), lanthanum carbonate, poly acrylamide (PAA), poly diallyldimethylammonium chloride (polyDADMAC), diatomatious earth (DE), and the like.

Exemplary implementations will now be described more fully hereinafter with reference to the accompanying drawings, in which exemplary implementations are shown. This invention may, however, be embodied in many different forms and should not be construed as limited to the exemplary implementations set forth herein. These exemplary implementations are provided so that this invention will be thorough and complete and will fully convey the scope of the invention to those of ordinary skill in the art. Moreover, all statements herein reciting exemplary implementations of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

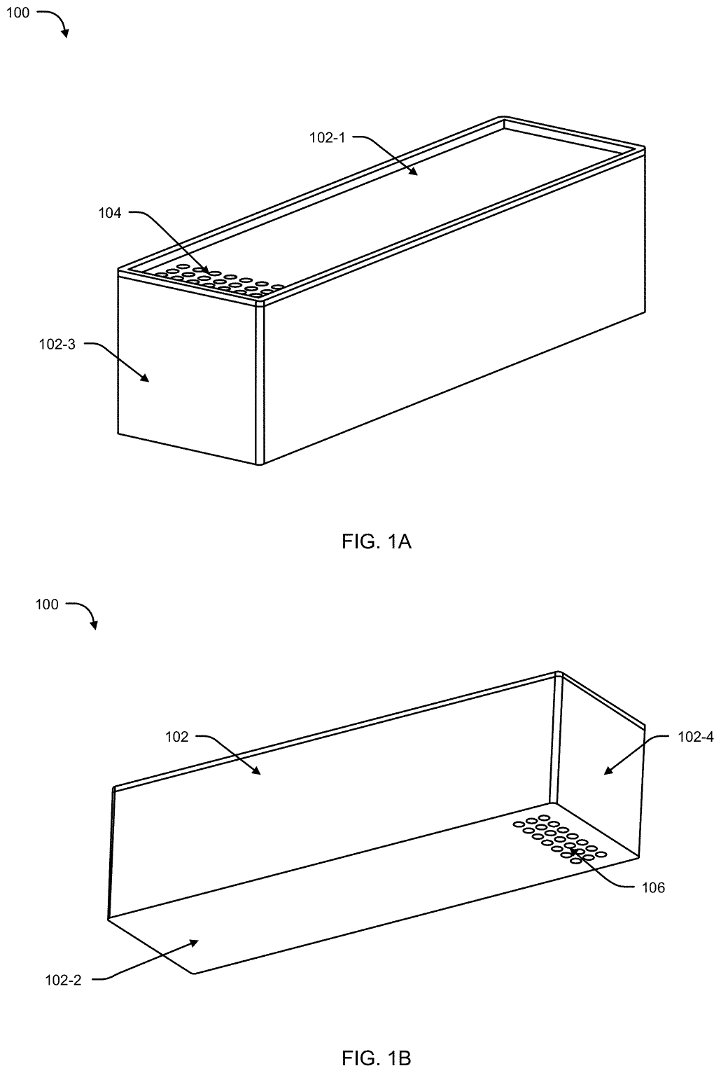

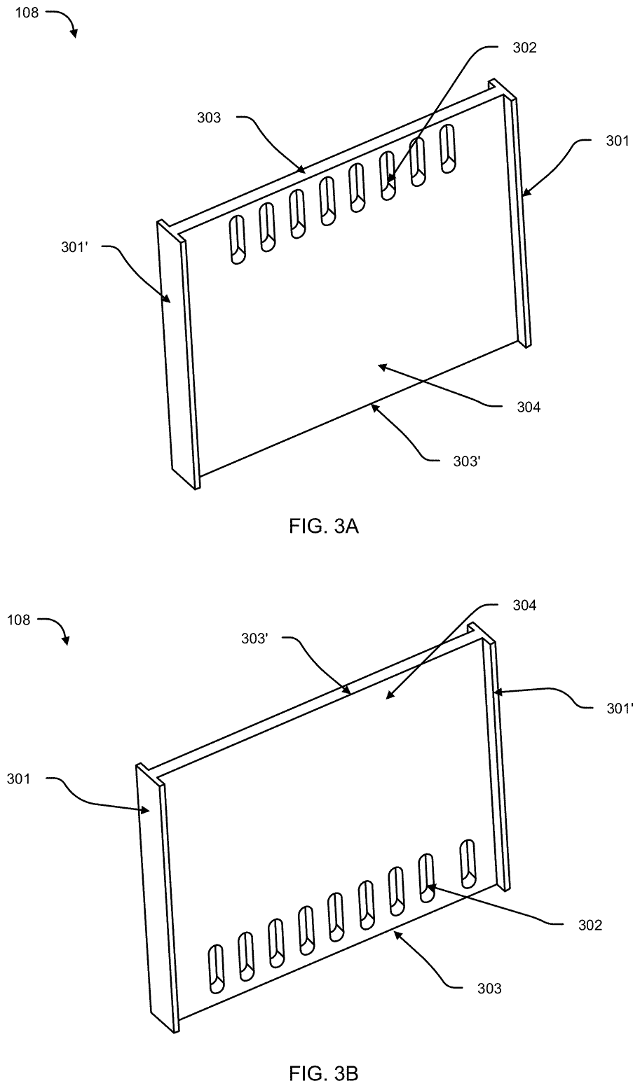

As illustrated in FIGS. 1A to 4, according to an aspect, the proposed water filter 100 for efficient and enhanced filtration and neutralization of different contaminants present in the water can include a housing 102 defining a central cavity. Housing 102 can include an inlet opening(s) 104 to receive water from a water reservoir or water source, and an outlet opening(s) 106 to discharge water out of housing 102. The filter 100 can include multiple partitions 108-1 to 108-6 (collectively referred to as partitions 106, herein) being parallelly placed at predefined positions within the housing 102 to form multiple compartments 110-1 to 110-7 (collectively referred to as compartments 110, herein) inside the housing 102. Each of these compartments 110 can be shaped and sized to accommodate filtration media container 402 corresponding to the contaminants to be filtered or neutralized in the water. As illustrated in FIGS. 3A-3B, the partition 108i can define opening(s) 302 (also referred to as first apertures 302, herein) at their first end 303, and a second end 303′ of the partitions opposite to the first end can have a solid surface 304. Partitions 108i having an I-shaped cross section with flanged lateral walls 301, 301′ can be configured in housing 102 such that two adjacent partitions are oriented in opposite direction (rotated by 180 degrees) from each other so that the opening(s) 302 of one of the two adjacent partitions faces the solid surface of the second end of the other adjacent partition. For example, the partition 108-1 is will always be with opening(s) 302 toward its basal end 303, and be positioned 180° rotated from the partition 108-2 adjacent to 108-1. Partitions 108i can be shaped and sized equivalent to an inner dimension of the housing 102 (in other words, be accommodated within housing 102), so that the partitions completely fits within the housing 102 without any gap therebetween, and the water can flow between two compartments 110 only through their corresponding opening(s) 302.

Filter 100 can include one or more filtration media container(s) 402-1 to 402-7 (collectively referred to as filtration media container(s) 402, herein) being configured in at least one of compartments 110-1 to 110-7. Filtration media container(s) 402jj can be adapted to filter 100 and neutralize one or more contaminants present in the water while flowing across the length of corresponding compartments 110p (110-1 to 110-7). Filtration media container(s) 402j comprise one or more materials of predefined composition being configured in, for example, biodegradable cloth bag, the composition is based on the contaminants to be filtered, removed, or neutralized. The bag is made in an exemplary implementation of a material that is capable of allowing the water to pass through them but restrict the filled filtration media from leaching out of the bag.

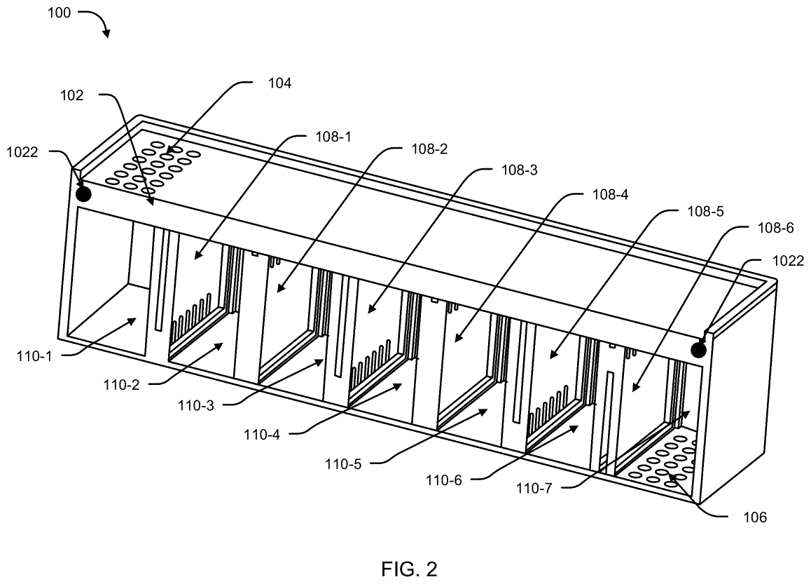

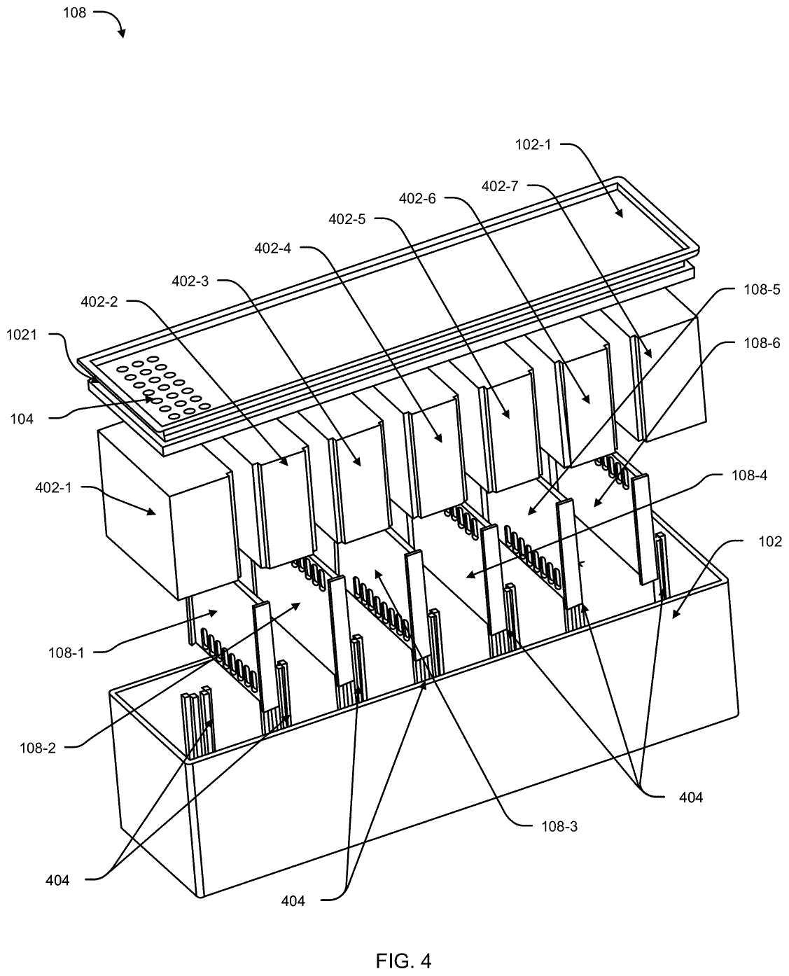

In an illustrative implementation, inlet opening104 defined toward an upstream end of housing 102 with internal side walls 1025 disposed in parallel with the housing's longitudinal axis XL, can be configured on surface (interchangeable with lid, or cover)102-1 having an upper surface and a lower surface defining peripheral groove 1021 (see e.g., FIG. 4), sized and configured to receive accommodate resilient O-ring 1022 (see e.g., FIG. 2), configured to engage housing 102 and opening in a first compartment 110-1 (also referred to as upstream end compartment 110-1, herein) at upstream facet 102-3 of the housing 102, and outlet opening(s) 106 can be configured on downstream facet 102-2 of housing 102 and opening in a second compartment 110-7 (also referred to as outlet end compartment 110-7, herein) at a second end 102-4 (opposite to the first end 102-3) of the housing 102, such that one or more third compartments 110-2 to 110-6 are formed between the first compartment 110-1 and the second compartment 110-7. This configuration of the inlet opening(s) 104 and outlet opening(s) 106 opening in the first compartment 110-1 and second compartment 110-7, respectively, along with alternate 180 degrees rotated partitions 108 within the housing 102, allows water to flow from the inlet opening(s) 104 to outlet opening(s) 106 through a length of each of the compartments from the first end 102-3 to the second end 102-4 of the housing 102, so that the contaminants present in water gets ample time to efficiently interact with the whole area of the filtration media, thereby providing efficient and enhanced filtration of water. To ensure complete emptying of the filter, the number of compartments 110p has to be even, such that the last partition 108i is positioned such that opening(s) 302 is (are) always positioned basally.

The inlet opening(s) 104 can be in form of a set of second apertures 104 (also referred to as second apertures 104, herein), and outlet opening(s) 106 can be in form of a set of third apertures 106 (also referred to as third apertures 106, herein) such that the second apertures 104 are uniformly present on the top surface over filtration media present in the first compartment 110-1, and the third apertures 106 are uniformly present on the bottom surface beneath the filtration media present in the second compartment 110-7. This uniform distribution of multiple second apertures 104 and third apertures 106 allow the water to enter housing 102 and efficiently pour-over or pass through the entire area of the filtration media present in the first compartment 110-1, as well as the second compartment 110-7.

As illustrated in FIG. 4, housing 102 can include one or more slots 404 (collectively referred to as slots 404, herein) positioned at the predefined positions within housing 102, and configured to accommodate and hold Partitions 108i within housing 102 to form the compartments 110. In the context of the disclosure, the term “accommodate” means that each partition 108, is operably slidably coupled to slots 404 and abut against the internal sidewall of housing 102. In an implementation, the term “slidably coupled” is used in its broadest sense to refer to elements which are coupled in a way that permits one element (e.g., partition 108) to slide or translate with respect to another element (e.g., slot 404)

In an exemplary implementation, at least one surface 102-1 of the housing 102 can be removably configured with the housing 102, to facilitate placement and removal of Partitions 108i, and filtration media container(s) 402 within and from the housing 102 as required.

As illustrated in FIGS. 2 and 4, in a first implementation, Partitions 108i can be configured perpendicular to the two opposite surfaces 102-1 and 102-2 (top and bottom surface) of the housing 102, at the predefined positions between the first end 102-3 (near the left surface) and the second end 102-4 (near the right surface) of the housing 102 to form the third compartments 110-2 to 110-6 being arranged in a horizontal direction between the first compartment 110-1 and the second compartment 110-7 of the housing 102.

In an implementation, the inlet opening(s) 104 and outlet opening(s) 106 can be configured near the upstream end and the downstream end of housing 102, respectively, on two opposite surfaces (interchangeable with lid, or cover) 102-1 and 102-2 (top and bottom) of housing 102 such that that inlet opening(s) 104 is at a predefined height above outlet opening(s) 106. Further, the uniform distribution of inlet opening(s) 104 and outlet opening(s) 106 allow the water to enter housing 102 and efficiently pour-over or pass through the entire area of filtration media container(s) 402j present in first compartment 110-1, as well as the second compartment 110-7. As a result, assuming an even number of compartments, the water from a water reservoir or water source can be uniformly poured from the top of housing 102 into the first compartment through inlet opening(s) 104. And under gravity, an automated flow of water can be enabled from one compartment to another in an alternate upward and downward direction fashion and finally coming out of the third slots 106 at the bottom surface in the second compartment 110-7 of housing 102, without any external pumping unit or means. This flow of water in an alternate upward and downward fashion across the length of adjacent compartments allows the water to get ample time to efficiently interact with the whole area of the corresponding filtration media, thereby providing efficient and enhanced filtration of water.

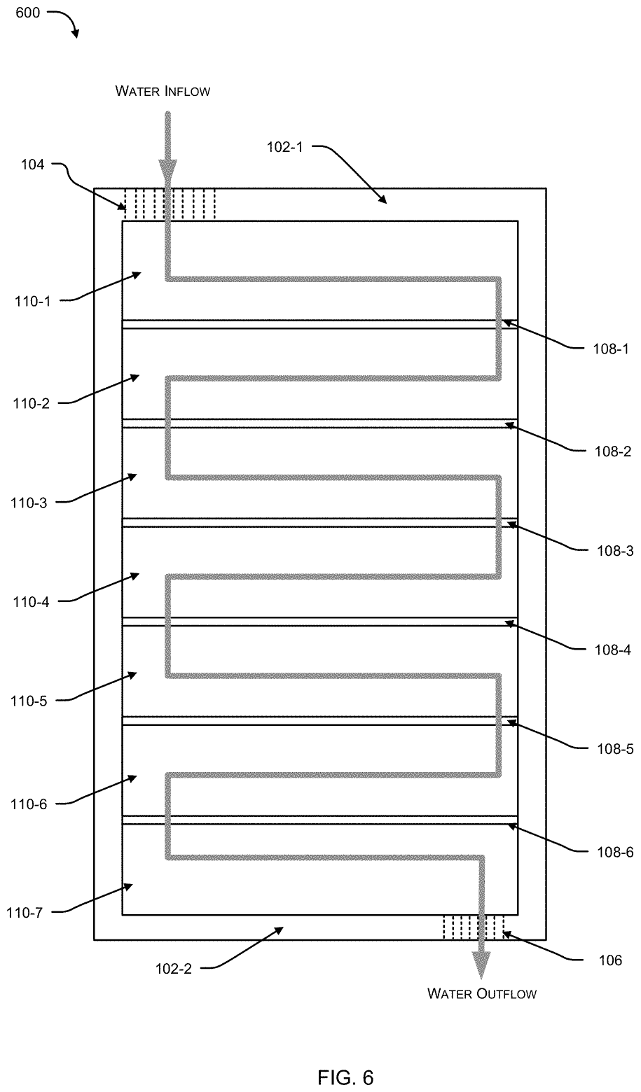

As illustrated in FIG. 6, in a second implementation of the proposed filter, Partitions 108i can be positioned parallelly to the two opposite surfaces 102-1 and 102-2 (top and bottom surface) of the housing, at predefined positions between the first end 102-1 (near the top surface) and the second end 102-2 (near the bottom surface) of the housing 104 to form the third compartments 110-2 to 110-6 being arranged in a vertical direction between the first compartment 110-1 at the top, and the second compartment 110-7 at the bottom.

In an implementation of the second implementation, inlet opening(s) 104 and the outlet 104 can be configured near the first end and the second end of housing 102, respectively, on two opposite surfaces 102-1 and 102-3 (top and bottom) of housing 102 such that that inlet opening(s) 104 is at a predefined height above outlet opening(s) 106. As a result, the water from a water reservoir or water source can be uniformly poured from the top of housing 102 into the first compartment 110-1 through inlet opening(s) 104, and under the effect of gravity, an automated flow of water can be enabled from one compartment to another in an alternate left and right direction fashion and finally coming out of the outlet at the bottom in the second compartment 110-7, without any external pumping unit or means. This flow of water in an alternate left and right direction across the length of adjacent compartments allows the water to get ample time to efficiently interact with the whole area of the corresponding filtration media container(s) 402, thereby providing efficient and enhanced filtration of water.

In a third implementation (not shown in Figures), the inlet and the outlet can be configured at a first end and a second end of the housing, respectively, on two adjacent surfaces of the housing such that that the inlet is configured at a predefined height above the outlet. For instance, the inlet can be configured on the top surface at the first end of the housing, and the outlet can be configured on a right surface or left surface adjacent to the top surface at the second end (opposite to the first end) of the housing. Alternatively, the inlet can be configured on a right surface or left surface adjacent to a bottom or top surface at the first end of the housing, and the outlet can be configured on the bottom surface of the housing. The partitions can be configured parallel to one of the two adjacent surfaces of the housing, at the predefined positions between the first end and the second end of the housing to form the compartments within the housing.

In an implementation of the third implementation, when the partitions are configured parallel to the left or right surface of the housing, the compartments are arranged in a horizontal direction between the left and right surface or first end and second end of the housing. In another implementation, when the partitions are configured parallel to the top surface, the compartments are arranged in a vertical direction between the top surface and bottom surface of the housing.

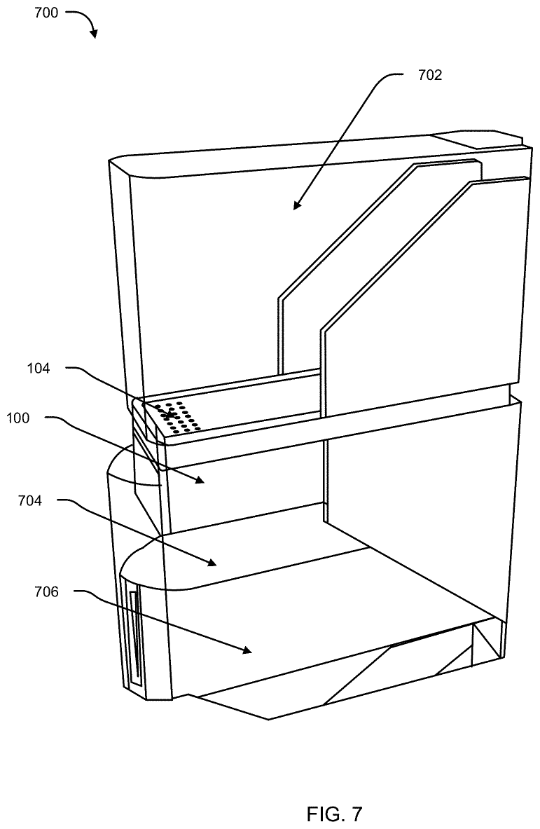

As illustrated in FIG. 7, according to an aspect, the present disclosure elaborates upon a water filtration apparatus 700 (also referred to as apparatus 700, herein) for efficient and enhanced filtration and neutralization of different contaminants present in the water. The apparatus 700 can include a first reservoir 702 configured to store water. Apparatus 700 can include the proposed filter 100 as illustrated in FIGS. 1A to 4A in the above paragraphs. The filter 100 having housing 102 defining a central cavity being fluidically coupled to the first reservoir 702, and positioned below the first reservoir 702. The filter 100 can include a housing 102 defining an inlet opening(s) 104 to receive water from the first reservoir 702, and an outlet opening(s) 106 to discharge filtered water out of housing 102. The filter 100 can include multiple partitions 108-1 to 108-6 (collectively referred to as partitions 108, herein) being parallelly placed at predefined positions within housing 102 to form multiple compartments 110-1 to 110-7 inside housing 102. Each of these compartments 110 can be shaped and sized to accommodate filtration media container 402 corresponding to the contaminants to be filtered or neutralized in the water. Partitions 108i can be provided with a set of first apertures 302 (also referred to as first apertures, herein) at their first end, and a second end of the partitions opposite to the first end can have a solid surface 304. Partitions 108i can be configured in housing 102 such that two adjacent partitions are oriented in opposite direction (rotated by 180 degrees) from each other so that the first apertures of one of the two adjacent partitions faces the solid surface of the second end of the other adjacent partition. Partitions 108i can be shaped and sized equivalent to an inner dimension of housing 102 so that Partitions 108i completely fits within housing 102 without any gap therebetween, and the water can flow between two compartments only through their corresponding first apertures 302.

The apparatus 700 can include one or more filtration media container(s) 402-1 to 402-7 (collectively referred to as filtration media container(s) 402, herein) being configured in at least one of the compartments of the filter 100. Filtration media container(s) 402j can be adapted to filter and neutralize one or more contaminants present in the water while flowing across the length of the corresponding compartments. The filtration media comprises one or more materials of predefined composition being configured in a bag, based on the contaminants to be filtered or neutralize. The bag can be made of a material that is capable of allowing the water to pass through them but restrict the filled filtration media to come out of the bag.

The apparatus 700 can include a second reservoir 704 fluidically coupled to housing 102, and configured to receive and store the filtered and decontaminated water 706 from outlet opening(s) 106 of housing 102. In an exemplary implementation, the second reservoir 704 can be positioned below filter 100 so that gravity can facilitate the flow of water from the first reservoir 702 to the second reservoir 704 through filter 100.

In an illustrative implementation, the first reservoir 702 of the apparatus 700 can be configured on top of housing 102 of the filter being in liquid communication with a first compartment 110-1 (also referred to as upstream,or inlet end compartment, herein) at the upstream end of housing 102, through inlet opening(s) 104 provided on the top surface of the filter 100. Further, the second reservoir 704 can be configured on bottom of housing 102 and fluidically coupled to a second compartment 110-7 (also referred to as outlet end compartment 107, herein) at a second end (opposite to the first end) of housing 102, through outlet opening(s) 106 provided on the bottom surface of the filter 100, such that one or more third compartments 110-1 to 110-6 are formed between the first compartment 110-1 and the second compartment 110-7. This fluidic coupling of the first reservoir 702 and the second reservoir 704 with the first compartment 110-1 and second compartment 110-7, respectively, along with alternate 180 degrees rotated partitions within housing 102, allows water to flow from the first reservoir 702 to the second reservoir 704 through a length of each of the compartments from the first end to the second end of housing 102, so that the contaminants present in water gets ample time to efficiently interact with the whole area of the filtration media, thereby providing efficient and enhanced filtration of water.

Inlet opening(s) 104 can be in form of a set of second apertures (also referred to as second apertures, herein), and outlet opening(s) 106 can be in form of a set of third apertures (also referred to as third apertures, herein) such that the second apertures are uniformly present on the top surface over filtration media container(s) 402-1 present in the first compartment 110-1, and the third apertures 106 are uniformly present on the bottom surface beneath filtration media container(s) 402j-7 present in the second compartment 110-7. This uniform distribution of multiple second apertures 104 and third apertures 106 allow the water to enter into the filter from the first reservoir 702 and efficiently pour-over or pass through the entire area of the filtration media present first compartment 110-1 and the third compartments 110-2 to 110-6, and further enable water to uniformly flow in the entire area of the filtration media of the second compartment 110-7 also.

In an exemplary implementation, Partitions 108i of the apparatus 700 can be configured perpendicular to the two opposite surfaces (top and bottom surface) of housing 102, at the predefined positions between the first end (near the left surface) and the second end (near the right surface) of housing 102 of the filter to form the third compartments 110-2 to 110-6 being arranged in the horizontal direction between the first compartment 110-2 and the second compartment 110-7 of housing 102.

In an implementation, inlet opening(s) 104 and outlet opening(s) 106 of the filter can be configured near the first end and the second end of housing 102, respectively, on two opposite surfaces (top and bottom) of housing 102 such that that inlet opening(s) 104 is at a predefined height above outlet opening(s) 106. The first reservoir 702 can be positioned on top of the filter, and the second reservoir 704 can be positioned at the bottom of the filter. Further, the uniform distribution of multiple second apertures 104 and third apertures 106 allow the water to enter the filter 100 from the first reservoir 702 and efficiently pour-over or pass through the entire area of the filtration media present first compartment, and also allowing water to uniformly flow through the entire area of the filtration media in the second compartment 110-7. As a result, the water from the first reservoir 702 can be uniformly poured from the top of housing 102 into the first compartment 110-1 through inlet opening(s) 104. And under the effect of gravity, an automated flow of water can be enabled from one compartment to another in an alternate upward and downward direction fashion and finally coming out of outlet opening(s) 106 at the bottom surface in the second compartment 110-7 of housing 102 into the second reservoir 704, without any external pumping unit or means. This flow of water in an alternate upward and downward fashion across the length of adjacent compartments allows the water to get ample time to efficiently interact with the whole area of the corresponding filtration media, thereby providing efficient and enhanced filtration of water.

According to an aspect, the present disclosure elaborates upon a water filter comprising a housing enclosing a central cavity, the housing comprises, an inlet to facilitate inflow of water into the housing, and an outlet opening to facilitate outflow of the water from the housing; one or more partitions having a set of first apertures at its first end, the one or more partitions being configured parallelly at predefined positions within the housing to from at least two compartments between the inlet and the outlet, wherein two adjacent partitions among the one or more partitions are oriented in opposite direction from each other such that the set of first apertures associated with one of the two adjacent partitions faces a second end of the other adjacent partition, and wherein the set of first apertures associated with the one or more partitions allows the water to flow from the inlet to the outlet through a length of each of the at least two compartments, and one or more filtration media configured in at least one of the at least two compartments, wherein the one or more filtration media are adapted to filter and neutralize one or more contaminants present in the water while flowing across the length of the corresponding compartments.

In an exemplary implementation, the housing comprises one or more slots positioned at the predefined positions within the housing, and configured to accommodate and hold the one or more partitions within the housing to form the at least two compartments.

In an exemplary implementation, the inlet comprises a set of second apertures, and the outlet comprises a set of third apertures.

In an exemplary implementation, the inlet and the outlet are configured at a first end and a second end of the housing, respectively, on two opposite surfaces of the housing such that that the inlet is at a predefined height above the outlet.

In an exemplary implementation, the one or more partitions are configured perpendicular to the two opposite surfaces of the housing, at the predefined positions between the first end and the second end of the housing to form the at least two compartments between the inlet and the outlet.

In an exemplary implementation, the one or more partitions are configured parallelly to the two opposite surfaces of the housing, at the predefined positions between the two opposite surfaces to from at least two compartments between the inlet and the outlet in the housing.

In an exemplary implementation, the inlet and the outlet are configured at a first end and a second end of the housing, respectively, on two adjacent surfaces of the housing such that that the inlet is configured at a predefined height above the outlet.

In an exemplary implementation, the one or more partitions are configured parallel to one of the two adjacent surfaces of the housing, at the predefined positions between the first end and the second end of the housing to form the at least two compartments between the inlet and the outlet.

In an exemplary implementation, at least one surface of the housing is removably configured with the housing.

According to another aspect, the present disclosure elaborates upon water filtration apparatus comprising, a first reservoir configured to store water, a housing enclosing a central cavity being fluidically coupled to the first reservoir, and positioned below the first reservoir, wherein the housing comprises an inlet to facilitate inflow of water from the first reservoir into the housing, and an outlet opening to facilitate outflow of the water from the housing; one or more partitions having a set of first apertures at its first end, the one or more partitions being configured parallelly at predefined positions within the housing to from at least two compartments between the inlet and the outlet, wherein two adjacent partitions among the one or more partitions are oriented in opposite direction from each other such that the set of first apertures associated with one of the two adjacent partitions faces a second end of the other adjacent partition, and wherein the set of first apertures associated with the one or more partitions allows the water to flow from the inlet to the outlet through a length of each of the at least two compartments, and one or more filtration media configured in at least one of the at least two compartments, wherein the one or more filtration media are adapted to filter and neutralize one or more contaminants present in the water while flowing through the length of the corresponding compartments.

In an exemplary implementation, the apparatus comprises a second reservoir fluidically coupled to the housing, and configured to receive the filtered and decontaminated water from the outlet of the housing.

In an exemplary implementation, the first reservoir is adapted to be removably coupled on an upper surface of the housing, and the second reservoir is adapted to be removably coupled on a bottom surface of the housing.

In an exemplary implementation, the inlet is configured on the upper surface, and the outlet is configured on the bottom surface such that that the inlet is at a predefined height above the outlet.

In an exemplary implementation, the one or more partitions are configured perpendicular to the upper surface and the bottom surface of the housing to form the at least two compartments between the inlet and the outlet.

In an exemplary implementation, the one or more partitions are configured parallelly to the upper surface and the bottom surface of the housing to from the at least two compartments between the inlet and the outlet.

In the following description, numerous specific details are set forth in order to provide a thorough understanding of exemplary implementations of the present invention. It will be apparent to one skilled in the art that exemplary implementations of the present invention may be practiced without some of these specific details.

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

In the context of the disclosure, the term “engage” and various forms thereof, refer to the application of any forces that tend to hold members, components, or elements together against inadvertent or undesired separating forces (e.g., such as may be introduced during use of the filter). The term “engaged” may particularly mean frictional coupling or the interlocking of two or more components of the filter device, e.g. a spline, thread, or meshed teeth connection. It is to be understood, however, that engagement of the elements, components or members does not in all cases require an interlocking connection that is maintained against every conceivable type or magnitude of separating force.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” comprises plural reference unless the context clearly dictates otherwise. Also, as used in the description herein, the meaning of “in” comprises “in” and “on” unless the context clearly dictates otherwise.

The phrases “in an exemplary implementation,” “according to one implementation,” and the like generally mean the particular feature, structure, or characteristic following the phrase is included in at least one implementation of the present disclosure, and may be included in more than one implementation of the present disclosure. Importantly, such phrases do not necessarily refer to the same implementation.

While exemplary implementations of the present invention have been illustrated and described, it will be clear that the invention is not limited to these exemplary implementations only. Numerous modifications, changes, variations, substitutions, and equivalents will be apparent to those skilled in the art, without departing from the spirit and scope of the invention, as described in the claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

In the context of the disclosure, the term “operable” means the system and/or the device, or a certain element is fully functional, sized, adapted and calibrated, comprises elements for, and meets applicable operability requirements to perform a recited function when activated, coupled, implemented, actuated, effected, or realized when associated with the system and/or the device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various exemplary implementations of the invention, other and further exemplary implementations of the invention may be devised without departing from the basic scope thereof. The scope of the invention is determined by the claims that follow. The invention is not limited to the described exemplary implementations, versions or examples, which are included to enable a person having ordinary skill in the art to make and use the invention when combined with information and knowledge available to the person having ordinary skill in the art.

We claim:

1. A water filter comprising:
a housing enclosing a central cavity, the housing comprising:
an inlet to facilitate inflow of water into the housing, and
an outlet opening to facilitate outflow of the water from the housing;
one or more partitions, each defining at least one opening at its first end, the one or more partitions being configured parallelly at predefined positions within the housing to form an even numbers compartments between the inlet and the outlet, wherein the at least one opening in each of the two adjacent partitions among the one or more partitions are oriented in opposite direction from each other such that the at least one opening associated with one of the two adjacent partitions faces a second end of the other adjacent partition, and
wherein the at least one opening associated with the one or more partitions is configured to allow the water to flow from the inlet to the outlet through a length of each of the even number of compartments; and
one or more filtration media container, disposed in at least one of the even number of compartments, wherein the one or more filtration media container is operable to filter, remove, or neutralize one or more contaminants present in the water.

2. The filter of claim 1, wherein the housing's internal side walls disposed in parallel with the housing's longitudinal axis, comprises one or more slots positioned at predefined positions within the housing, each slot configured to engage a portion of the one or more partitions within the housing to form an even number of compartments.

3. The filter of claim 1, wherein the inlet opening define a first set apertures, and the outlet opening comprises a second set apertures.

4. The filter of claim 1, wherein the inlet opening and the outlet opening are configured at an upstream end and a downstream end of the housing, respectively such that that the inlet opening is at a predefined height above the outlet opening.

5. The filter of claim 4, wherein the one or more partitions are disposed perpendicular to the housing's longitudinal axis, at predefined positions between the upstream end and the downstream end of the housing to form the even number of compartments between the inlet opening and the outlet opening.

6. The filter of claim 1, wherein at least one surface of the housing is frictionally engaged to the housing.

7. A water filtration apparatus comprising:
a first reservoir configured to store water;
a housing enclosing a central cavity in fluid communication with the first reservoir, and positioned below the first reservoir, wherein the housing comprises an inlet opening to facilitate inflow of water from the first reservoir into the housing, and an outlet opening to facilitate outflow of the water from the housing;
one or more partitions having at least one opening at a basal or apical end, the one or more partitions being configured parallelly at predefined positions within the housing wherein the at least one basal or apical opening in adjacent partitions are oriented opposite direction from each other, and
wherein the at least one opening associated with the one or more partitions allows the water to flow from the inlet opening to the outlet through a length of each of the compartments; and
one or more filtration media container, disposed within at least one of the compartments, wherein the one or more filtration media container is operable to filter, remove, or neutralize one or more contaminants present in the water while flowing through the length of the corresponding compartments.

8. The water filtration apparatus of claim 7, wherein the apparatus comprises a second reservoir in fluid communication with the housing, and configured to receive the filtered and decontaminated water from the outlet opening of the housing.

9. The water filtration apparatus of claim 8, wherein the first reservoir is removably coupled to an upper surface of the housing, and the second reservoir is removably coupled to a bottom surface of the housing.

10. The water filtration apparatus of claim 9, wherein the inlet opening is defined on the upper surface, and the outlet opening is defined on the bottom surface such that that the inlet opening is at a predefined height above the outlet opening.

11. The water filtration apparatus of claim 10, wherein the one or more partitions are disposed perpendicular to the housing's longitudinal axis, at predefined positions between the upstream end and the downstream end of the housing to form the compartments between the inlet opening and the outlet opening.

12. The water filtration apparatus of claim 10, wherein the one or more partitions are configured parallelly to the upper surface and the bottom surface of the housing to form the at least two compartments between the inlet opening and the outlet opening.

13. The water filtration apparatus of claim 12, wherein the filtration media container is at least one of: a cloth container, a plastic container, and a metal container.
